(19) United States
(12) Patent Application Publication
(10) Pub. No.: US 2016/0234533 A1
(43) Pub. Date: Aug. 11, 2016

(54) GINGA ARCHITECTURE FOR INTEGRATED BROADCAST AND BROADBAND DIGITAL TELEVISION

(71) Applicant: Faculdades Católicas, Mantenedora da Pontificia Universidade Católica do Rio de Janeiro - PUC RIO, Rio de Janeiro (BR)

(72) Inventors: Luiz Fernando Gomes Soares, Rio de Janeiro (BR); Marcelo Ferreira Moreno, Juiz de Fora (BR)

(73) Assignee: Faculdades Católicas, Mantenedora da Pontificia Universidade Católica do Rio de Janeiro - PUC RIO, Rio de Janeiro (BR)

(21) Appl. No.: 15/016,715

(22) Filed: Feb. 5, 2016

Related U.S. Application Data
(60) Provisional application No. 62/112,875, filed on Feb. 6, 2015.

(51) Int. Cl. H04N 21/235; H04N 21/478

(52) U.S. Cl. CPC H04N 21/2353; H04N 21/478

(57) ABSTRACT

Ginga IBB applies to any Broadcast service (terrestrial TV, satellite TV, cable TV, IPTV) where the TV receivers are connected not only to a broadcast channel, but also to a broadband channel, from where multimedia applications can get more content to enrich end user experience in linear and non-linear TV services.

### STATEMENT OF RELATED APPLICATIONS

This patent application is a non-provisional of, and claims the benefit of, U.S. Provisional Patent Application No. 62/112,875 having a filing date of 6 Feb. 2015.

### BACKGROUND OF THE INVENTION

1. Technical Field

Ginga IBB applies to any Broadcast service (terrestrial TV, satellite TV, cable TV, IPTV) where the TV receivers are connected not only to a broadcast channel, but also to a broadband channel, from where multimedia applications can get more content to enrich end user experience in linear and non-linear TV services.

2. Prior Art

An Integrated Broadcast-Broadband (IBB) service is defined in Recommendation ITU-T J.205 [1] as “A service that simultaneously provides an integrated experience of broadcasting and interactivity relating to media content, data and applications from multiple sources, where the interactivity is sometimes associated with broadcasting programmes”. From the same specification it is worth mentioning the following excerpt:
Due to the one-way nature of the broadcast channel, the broadcast DTV services are linear: exactly the same content is delivered to all the users at a given time.
With the widespread adoption of high-speed broadband Internet services, a new delivery channel becomes available, the broadband channel. This new channel not only allows the delivery of linear content but also, thanks to its two-way nature, non-linear (on-demand) content.
Both kinds of channels have their strong and weak points. By combining both of them, it is possible to DTV services that can take advantage of all the strong points from each one. In this case, some DTV service components can be delivered through the broadcast channel and some other components can be delivered through the broadband channel. These kinds of services are considered to be IBB DTV services.

IBB is indeed a kind of converged service where a receiver device (TV) is able to connect to different delivery networks. But only recently the TV became able to do this. Interactive digital TV services already existed before IBB initiatives. Some established, standardized technologies like Ginga [2] [3] supported the creation of multi-sourced multimedia content since their conception. For this reason, Ginga promptly preformed a key role to contribute to the definition of IBB requirements, architecture, systems and services.

However, to enable full IBB services, the IBB system architecture should be able to “harmonize the behavior and the interaction of a variety of types of applications, provided by network agnostic delivery mechanisms, including applications that are broadcast-delivered, broadband-delivered, pre-installed, installed via an application repository, or home area network delivered” [1]. An IBB system must incorporate an application control framework that coordinates the coexistence of digital television (DTV) services, IBB services and its various types and sources of applications.

This invention describes a comprehensive architecture for Ginga in an IBB scenario. The architecture presents novel design decisions and features that make it a superior solution if compared with current similar technologies.

There are two other technologies applied in the same field with similar purposes: HbbTV and HybridCast.

The Hybrid Broadcast Broadband TV (HbbTV) [4] combines TV services delivered via broadcast with services delivered via broadband and also enables access to Internet only services for consumers using connected TVs and set-top boxes. The HbbTV specification is based on existing standards and web technologies (XHTML 1.0, DOM 2, CSS 1, EcmaScript). It is a proposal from ETSI that succeeds its former middleware specification called Multimedia Home Platform (MHP) for interactive digital television. HbbTV is a whole new specification that is not compatible with MHP. IBB and non-IBB services can coexist in a DTV system that adopts HbbTV by properly signaling. HbbTV 2.0 finally added support for some kind of media synchronization, companion devices and new media types, a set of features that were not supported in previous versions. HTML5 became the base language included in HbbTV 2.0.

Hybridcast [5] uses HTML5 and is standardized in Japan as a second generation of multimedia coding specification that succeeds the first one, based on BML. The specification is completely new, but HybridCast receivers can present BML applications. The system offers a variety of services through a combination of broadcast and broadband telecommunication resources and features. Features also include basic support for companion devices and synchronization via stream events only.

Drawbacks to the prior art:

The existent IBB systems, excluding the one involved in this invention, have some drawbacks and technical limitations as follows:
Existent IBB solutions are completely new proposals that are not related to their respective, legacy, DTV middleware. Those specifications at least permit coexistence of IBB and non-IBB applications, but they changed all the APIs and base languages. Therefore, existent DTV applications must be completely rewritten to take advantage of the new IBB platform.
The main focus of current IBB systems has been on application control (signaling). Even the recent updates still suffer for limited support for media synchronization and basic companion device functions, which are important requirements for such an application scenario.
There is no structured management that defines how to persist applications and their content. A persistence subsystem based on a formal structure allows for the creation of APIs between broadcasters and IBB receivers that support a comprehensive control of the application lifecycle. Those APIs should also be accessible by Graphical Interfaces that would allow the user to also take control of the application lifecycle. Furthermore, applications from a unique source should be able to take control of another one by means of such an API.
There is no reflective representation of persisted and non-persisted content included in the applications that the applications themselves could explore. It is not possible to insert an existent application into another one (both already installed or being broadcasted). We can rapidly explain how useful such a feature is by citing the mobile application platforms like Android and iOS, which allows for the integration between existent applications so each one can take benefit from the functions of the other.
Application lifecycle can be controlled, but only using AIT signaling (via broadcast or broadband channels). AIT is a table included in the broadcasted MPEG-2 Service Information (SI) that indexes the applications available in that MPEG-2 transport stream or the ones that should be made available from the broadband channel. It also contains signaling data that informs if the application should be stored or not, and a few other options. As an MPEG-2 SI table, AIT has a restrictive structure and thus limited functionalities. Some existent IBB systems support Broadband signal by supporting the reception of AIT as an XML file, however with the same drawbacks.
There is no support for the broadcaster to change the behavior of applications in real time, i.e. live editing support. Once the application has been received, broadcasters cannot change their behavior. For a similar purpose, current IBB systems require that the application itself must gather more information from servers via the broadband channel (only), in a pre-programmed way.
Base language in use (HTML5) is a Web language that does not focus on IBB typical applications, which involves media synchronization, companion devices, content adaptation. These functionalities are somehow achievable with HTML5, but require an excessive programming expertise (not in HTML, but JavaScript) and complex programming code that, in the end, will still be limited.

### BRIEF SUMMARY OF THE INVENTION

### The Ginga Architecture

To be Ginga compliant, the Ginga Common-Core (Ginga-CC), Ginga-NCL and the Private Base Manager subsystems are required. However, Ginga allows for optional extensions, which includes execution engines based on other programming languages. To support IBB applications in agreement with ITU-T J.205, AppCatUI becomes a required extension.

In this invention, the Private Base Manager is considered a first-class entity of the Ginga IBB architecture, being positioned directly coupled to the Ginga Common-Core and used by Ginga-NCL, AppCatUI and Ginga extensions. The Private Base Manager centralizes all controlling commands over IBB applications' lifecycle, persistence and behavior changing. These commands may be issued by the broadcaster (via broadcast or broadband channels), by the user (via the AppCatUI) and by the applications themselves (via the Live Editing API).

The Ginga Common Core (Ginga-CC) is composed of media players, procedures to obtain contents that can be transported in diverse (broadcast and broadband) networks accessed by a receiver, and the conceptual display graphical model defined by the receiver platform. The Ginga Common Core is also tasked with gathering metadata information and providing this information to NCL (Nested Context Language) applications; for providing an API to communicate with DRM system (8); for managing context information (like user profiles and receiver profiles); and for supporting software version management (update) of Ginga's components.

Media player components serve application needs for decoding and presenting content types, including perceptual media content and content that contains declarative or imperative code, like HTML code, Lua code, etc. A generic media player API establishes the necessary communication between media player components and the Ginga-NCL subsystem (2). Thanks to this API, Ginga-NCL and the Ginga-CC are strongly coupled but independent subsystems. Ginga-CC may be substituted by other third part implementations, allowing Ginga-NCL to be integrated in other DTV middleware specifications, extending their functionalities with NCL facilities. Players that do not follow the generic API are required to use the services provided by Adapters.

The core of Ginga-NCL subsystem is the NCL Player. This component is tasked with receiving and controlling multimedia applications authored in NCL. Applications are delivered to the NCL Player by the Ginga Common Core.

In Ginga-NCL, a declarative application can be generated or modified on the fly, using NCL editing commands [2].

NCL is the declarative language of Ginga. Its characteristics make it a sound declarative solution for IBB services: the language flexibility; its reuse facility; multi-device support; presentation and application content adaptability; API for building and modifying applications on-the-fly; and, mainly, its intrinsic ability for easily defining spatiotemporal synchronization among media assets (including viewer interactions). For particular procedural needs, e.g., when more complex dynamic content generation is required, NCL provides support to the Lua scripting language. Lua is a powerful, fast, lightweight, embeddable scripting language [2].

The NCL Player deals with NCL applications collected inside a data structure known as private base. A Private Base Manager component is tasked with receiving NCL editing commands and control commands delivered using AIT table control_code field, and maintaining the lifecycle of NCL applications being presented.

Ginga-NCL Presentation Engine supports multiple presentation devices (companion devices) through its Layout Manager module. This component is responsible for mapping all presentation regions defined in an NCL application to canvas on receiver's displays.

### BRIEF DESCRIPTION OF THE DRAWINGS

FIG. 1 describes Ginga Architecture;

FIG. 2 describes Tree data structure corresponding to the Private Base Data Structure; and

FIG. 3 describes Hierarchical device control model.

### DETAILED DESCRIPTION OF PREFERRED EMBODIMENTS

### The Ginga Architecture

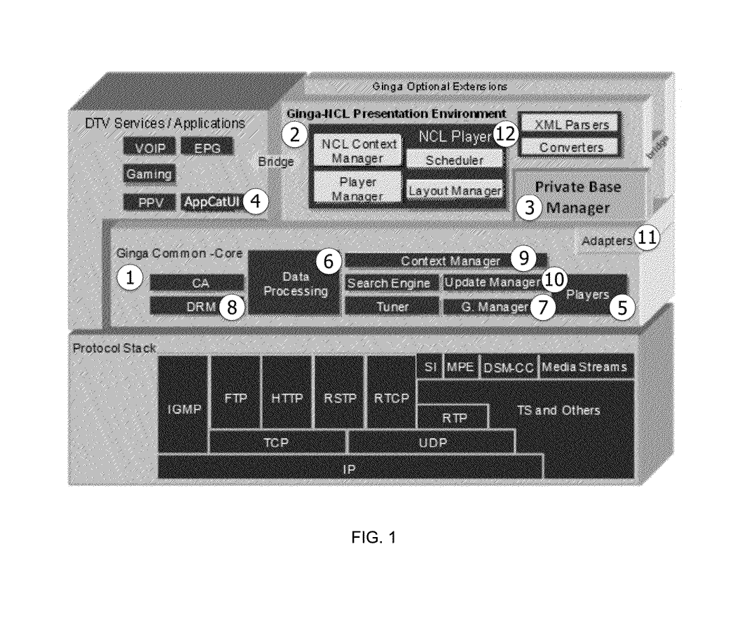

The Ginga architecture is depicted in FIG. 1. To be Ginga compliant, the Ginga Common-Core (Ginga-CC) 1, Ginga-NCL 2 and the Private Base Manager 3 subsystems are required. However, Ginga allows for optional extensions, which includes execution engines based on other programming languages. To support IBB applications in agreement with ITU-T J.205, AppCatUI 4 becomes a required extension.

In this invention, the Private Base Manager 3 is considered a first-class entity of the Ginga IBB architecture, being positioned directly coupled to the Ginga Common-Core 1 and used by Ginga-NCL 2, AppCatUI 4 and Ginga extensions. The Private Base Manager centralizes all controlling commands over IBB applications' lifecycle, persistence and behavior changing. These commands may be issued by the broadcaster (via broadcast or broadband channels), by the use (via the AppCatUI 4) and by the applications themselves (via the Live Editing API).

The Ginga Common Core (Ginga-CC) 1 is composed of media players 5, procedures to obtain contents that can be transported in diverse (broadcast and broadband) networks accessed by a receiver 6, and the conceptual display graphical model defined by the receiver platform 7. The Ginga Common Core 1 is also tasked with gathering metadata information 6 and providing this information to NCL applications; for providing an API to communicate with DRM system 8; for managing context information (like user profiles and receiver profiles) 9; and for supporting software version management (update) of Ginga's components 10.

Media player components 5 serve application needs for decoding and presenting content types, including perceptual media content and content that contains declarative or imperative code, like HTML code, Lua code, etc. A generic media player API establishes the necessary communication between media player components and the Ginga-NCL subsystem 2. Thanks to this API, Ginga-NCL 2 and the Ginga-CC 1 are strongly coupled but independent subsystems. Ginga-CC 1 may be substituted by other third part implementations, allowing Ginga-NCL to be integrated in other DTV middleware specifications, extending their functionalities with NCL facilities. Players 5 that do not follow the generic API are required to use the services provided by Adapters 11.

The core of Ginga-NCL 2 subsystem is the NCL Player 12. This component is tasked with receiving and controlling multimedia applications authored in NCL. Applications are delivered to the NCL Player 12 by the Ginga Common Core 1.

In Ginga-NCL 2, a declarative application can be generated or modified on the fly, using NCL editing commands [2].

NCL is the declarative language of Ginga. Its characteristics make it a sound declarative solution for IBB services: the language flexibility; its reuse facility; multi-device support; presentation and application content adaptability; API for building and modifying applications on-the-fly; and, mainly, its intrinsic ability for easily defining spatiotemporal synchronization among media assets (including viewer interactions). For particular procedural needs, e.g. when more complex dynamic content generation is required, NCL provides support to the Lua scripting language. Lua is a powerful, fast, lightweight, embeddable scripting language [2].

The NCL Player 12 deals with NCL applications collected inside a data structure known as private base. A Private Base Manager 3 component is tasked with receiving NCL editing commands and control commands delivered using AIT table control_code field, and maintaining the lifecycle of NCL applications being presented.

Ginga-NCL Presentation Engine 2 supports multiple presentation devices (companion devices) through its Layout Manager module. This component is responsible for mapping all presentation regions defined in an NCL application to canvas on receiver's displays.

The Private Base Data Structure (PBDS)

The core of Ginga is composed of the NCL Player 12 and the Private Base Manager 3 modules.

The NCL Player 12 is tasked with receiving an NCL application and controlling its presentation, trying to guarantee that the specified relationships among media objects are respected. The NCL Player 12 deals with applications that are collected inside a data structure known as private base. Applications in a private base may be edited, started, paused, resumed, aborted, stopped, saved and may refer to each other.

Ginga associates at least one private base with each TV channel (set of services)—the TV channel's default private base. When a certain TV channel is tuned, its corresponding default private base is opened and activated by the Private Base Manager 3. Other private bases can then be opened (or created), but at most one associated with each service of the TV channel. When a TV channel has just one service, it shall have just one private base associated with the TV channel (the default private base).

Resident applications are managed in a specific private base, as well as pre-installed applications.

The number of private bases that may be kept open is a decision of a specific middleware implementation.

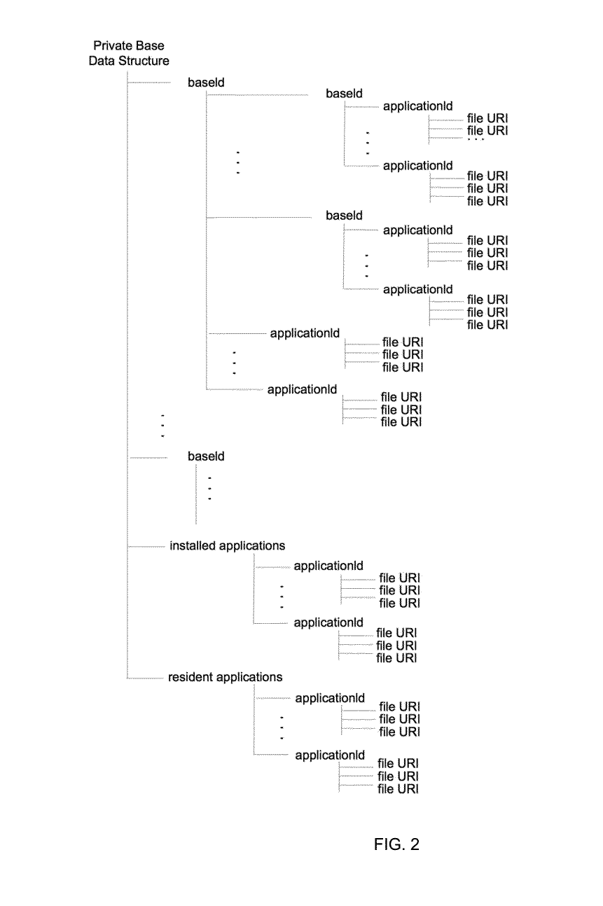

The Private Base Data Structure (PBDS) is summarized by Ginga in a tree structure, as illustrated in FIG. 2, to which read access is offered to applications. It is up to every subsystem of Ginga and Ginga's extensions the maintenance of this tree structure by means of the Private Base Manager 3.

The PBDS storage refers to application content on volatile memories, non-volatile memories, and ROM/firmware. Private bases and applications become persistent when explicitly saved, except for the persistent private base defined for resident applications.

Every node of the tree structure of FIG. 2 can have a set of associated information. The baseId node must have as associated information if the private base storage is persistent or not, and also the current state of the base (open, active, or closed). The applicationId node must have as associated information the minimum set of resources needed to be stored in the PBDS for an application to be started, and also if the application storage is persistent or not. The several applications' codes are represented by nodes placed as descendent of code nodes. The initial organization of these nodes is chosen by a specific Ginga implementation. All resources included in an application are represented by nodes in the PBDS. These nodes must have as associated information a URI that refers to the storage location of its corresponding content and if they are completely or partially stored. In the latter case, the node should also inform how close the stored content is to the end of storage.

Control of Private Bases and Applications

The Private Base Manager is tasked with receiving commands for managing private bases and controlling applications.

The first group of commands is for private base operations (to open, close, activate, deactivate, and save private bases); the second one for application manipulation (to add, remove, and save an application in an open private base and to start, pause, resume, and stop application executions in an active private base).

Commands to private base management can come embedded in operations to control the life cycle of the applications of the AIT, DSM-CC stream events, or events generated by applications. Commands can also be performed by default. For example, as the number of private databases that may be kept open is a decision of the middleware specific implementation, the simplest and restricted way to manage private bases is to have only one private base open at a time, among those controlled by the tuned DTV channel.

In this invention, the Private Base Manager 3 supports commands that controls the persistency and activity for private bases. The commands for manipulating private bases are:

| Command | Command | |
|---|---|---|
| string | tag | Description |
| openBase | 0x00 | Opens an existing private base. If the private |
| (baseId, | | base does not exist, a new base is created in |
| location) | | the PBDS. The PBDS is a nested structure, |
| | | where each traversal step is separated by “.” |
| | | The baseId parameter identifies the private |
| | | base, univocally, by means of the nested |
| | | traversal for the base in the PBDS. The |
| | | location parameter may be used to specify a |
| | | diverse location of the private base to be |
| | | opened in the PBDS. Thus, the location of a |
| | | private base by the location parameter takes |
| | | one of the following options: |
| | | For bases in receiver's internal memory, |
| | | location must be null, since the path in |
| | | the filesystem where the private base |
| | | is located will be inferred by the |
| | | middleware, taking as a basis the root |
| | | directory configured for persistency in |
| | | internal memory. |
| | | For bases in external memory, location's |
| | | value must be ‘extMem’. Similar to the |
| | | previous case, the path to the private |
| | | base in the external memory filesystem |
| | | must be inferred by the middleware, |
| | | taking as a basis the root directory |
| | | configured for persistency in external |
| | | memory. |
| | | Both root directories for persistency in internal |
| | | or external memories are designated and |
| | | unchanged by the Ginga implementer. Under |
| | | the concerned root directory, the middleware |
| | | must adopt a filesystem structure that allows |
| | | for the path inference mentioned above, |
| | | considering the storage of multiple private |
| | | bases, acquired from multiple sources |
| | | (different broadcasters, installed applications |
| | | and resident applications). As an example, |
| | | one may suggest that the complete path to a |
| | | private base should be the concatenation of |
| | | the root directory with a path component that |
| | | contains the value of the baseId of such |
| | | private base. |
| activateBase | 0x01 | Turns on an open private base. All its |
| (baseId) | | applications are then available to be started. |
| | | If the private base is not opened, ignores the |
| | | command. |
| deactivateBase | 0x02 | Turns off an open private base. All its running |
| (baseId) | | applications shall be stopped. |
| | | If the private base is not opened, ignores the |
| | | command |
| saveBase | 0x03 | Saves all applications of the private base into |
| (baseId, | | a persistent storage device (if available). The |
| location) | | location parameter may be used to specify a |
| | | diverse location for saving the base content. |
| | | The same rule for composing the value of the |
| | | location parameter described above for the |
| | | openBase command applies to saveBase. If |
| | | saved in a external storage device, the |
| | | application integrity must be guaranteed by |
| | | the middleware so the application can be later |
| | | executed. In order to make an application |
| | | persistent, it is necessary that all files |
| | | transferred with no request (pushed data) to |
| | | be stored in the PBDS. |
| closeBase | 0x04 | Closes the open private base and disposes all |
| (baseId) | | private base content. |
| | | If the private base is not opened, ignores the |
| | | command |
| removeBase | 0x35 | Removes the referred closed base from the |
| (baseId) | | PBDS. |

In addition to the command to save the entire private base, an application can also be saved by a specific command.

Several commands are defined for manipulating NCL applications of a private base. Commands to add, remove and save an application in an open private base and to start, pause, resume, and stop application presentations in an active private base are defined. Operations to control the life cycle of applications via AIT can also be mapped to these same functions for Ginga applications. In this invention, therefore, applications, broadcasters and users may perform changes in the application's lifecycle and persistency, that are deployed by means these commands. Furthermore, these commands allow for choosing the type of memory to be used in persistency-related operations.

The commands for manipulating NCL applications of a private base are:

| | Command | |
|---|---|---|
| Command String | Tag | Description |
| addDocument | 0x05 | Adds an NCL document to an open |
| (baseId, {uri, id}+) | | private base. The NCL document's files |
| | | can be: |
| | | i) sent via the datacast network as a set |
| | | of pushed files (unsolicited); in this |
| | | case {uri, id} pairs are used to relate a |
| | | set of file paths specified in the NCL |
| | | document with their respective |
| | | locations in a transport system; |
| | | The set of reference pairs shall be |
| | | sufficient so that the middleware will be |
| | | able to map any file reference specified |
| | | in the NCL document into its concrete |
| | | location in the receiver's memory. |
| | | ii) received via the broadband channel |
| | | as a set of pulled files (on demand), or |
| | | are already resident in the receiver; for |
| | | these files, no {uri, id} pairs need to be |
| | | sent, except the {uri, “null”}pair |
| | | associated with the NCL document, |
| | | which must be added to the baseId |
| | | base, if the NCL document is not |
| | | received unsolicitedly. |
| | | NOTE: This command states that only |
| | | the specified NCL document shall be |
| | | added to an open private base, letting a |
| | | particular middleware implementation |
| | | to decide when and which contents or |
| | | other children NCL applications must |
| | | be stored. |
| addApplication | 0x36 | Adds an NCL application to an open |
| (baseId, {uri, id}+, | | private base. The NCL application's |
| applicationId, | | files can be: |
| {minResourceURI}+, | | i) sent via the datacast network as a set |
| [NVStorageURI]+) | | of pushed files (unsolicited); in this |
| | | case {uri, id} pairs are used to relate a |
| | | set of file paths specified in the NCL |
| | | document with their respective locations |
| | | in a transport system. |
| | | The set of reference pairs shall be |
| | | sufficient so that the middleware will be |
| | | able to map any file reference specified |
| | | in the NCL document into its concrete |
| | | location in the receiver's memory. |
| | | ii) received via the broadband channel |
| | | as a set of pulled files (on demand), or |
| | | are already resident in the receiver; for |
| | | these files, no {uri, id} pairs need to be |
| | | sent, except the {uri, “null”} pair |
| | | associated with the NCL document, |
| | | which must be added to the baseId |
| | | base, if the NCL document is not |
| | | received unsolicitedly. |
| | | The applicationId parameter |
| | | corresponds to the <ncl> element's id |
| | | attribute of the NCL document, which |
| | | is the application's entry point. |
| | | The minResourceURI list contains the |
| | | URIs (separated by comma) for files |
| | | that must be already stored in memory |
| | | before the application presentation |
| | | starts.This parameter may be omitted, |
| | | meaning that the application can be |
| | | started independently of the files loaded |
| | | in memory (in this case, a particular |
| | | Ginga implementation decides on |
| | | which resources must be in memory |
| | | before starting an application), or may |
| | | have assigned the [all] value, which |
| | | means that all files unsolicitedly |
| | | transmitted (pushed data) must be |
| | | available in memory. |
| | | The NVStorageURI list contains the |
| | | URIs (separated by comma) for files |
| | | that are recommended to be stores in |
| | | non-volatile memory. This parameter |
| | | may be omitted, meaning that there is |
| | | no recommendation, or may have |
| | | assigned the [all] value, which means |
| | | that all files unsolicitedly transmitted |
| | | (pushed data) are recommended to be |
| | | stored in non-volatile memory. |
| | | NOTE: This command states that all |
| | | files transmitted unsolicitedly (pushed |
| | | data) must be stored. |
| remove Application | 0x37 | Removes an NCL application from an |
| (baseId, | | open private base. The application must |
| applicationtId) | | be stopped if it is currently running. |
| remove Document | 0x06 | Removes an NCL document from an |
| (baseId, | | open private base. |
| documentId) | | |
| startDocument | 0x07 | Starts playing an NCL document in an |
| (baseId, | | active private base, beginning the |
| documentId, | | presentation from a specific document |
| interfaceId, offset, | | interface. The time reference provided |
| tbvBaseId, | | in the tbvTrigger field defines the initial |
| tbvTrigger) | | time positioning of the application with |
| NOTE. The offset | | regards to the time base identified in |
| parameter is a time | | the tbvBaseId field. Three cases may |
| value. | | happen: |
| | | i) If tbvTrigger is different from 0 and |
| | | is greater than or equal to the current |
| | | time base value of the time base |
| | | identified by the tbvBaseId, the |
| | | document presentation shall wait until |
| | | time base has the value specified in |
| | | tbvTrigger to be started from |
| | | its beginning time + offset. |
| | | ii) If tbvTrigger is different from 0 and |
| | | is less than the current value of the time |
| | | base identified by the tbvBaseId, |
| | | the application shall be started |
| | | immediately from its beginning time + |
| | | offset + (time base value— |
| | | tbvTrigger)seconds |
| | | NOTE. Only in this case, the offset |
| | | parameter value may be a negative time |
| | | value, but offset + (time base value— |
| | | tbvTrigger)seconds shall be a positive |
| | | time value. |
| | | iii) If tbvTrigger is equal to 0, the |
| | | application shall start its presentation |
| | | immediately from its beginning time + |
| | | offset |
| | | If the interfaceId parameter is specified |
| | | as “null”, all <port> element of the |
| | | <body> element shall be triggered |
| | | (started). If the offset parameter is |
| | | specified as “null”, it shall assume “0” |
| | | as value. |
| stopDocument | 0x08 | Stops the presentation of an NCL |
| (baseId, | | application in an active private base. All |
| documentId) | | application events that are occurring |
| | | shall be stopped. |
| pauseDocument | 0x09 | Pauses the presentation of an NCL |
| (baseId, | | application in an active private base. All |
| documentId) | | application events that are occurring |
| | | shall be paused. |
| resumeDocument | 0x0A | Resumes the presentation of an NCL |
| (baseId, | | application in an active private base. All |
| documentId) | | previously application events that were |
| | | paused by the pauseDocument Editing |
| | | Command shall be resumed. |
| saveApplication | 0x3C | Makes persistent an NCL application |
| (baseId, | | from an open private base to a non- |
| applicationId, | | volatile storage device (if available). |
| location) | | The location parameter may be used to |
| | | specify a diverse location for saving the |
| | | document. The same rule for |
| | | composing the value of the location |
| | | parameter described for the openBase |
| | | command applies to saveApplication. |
| | | If the application is saved to an external |
| | | storage device, application integrity |
| | | must be guaranteed by the middleware |
| | | so it can be later executed. If the |
| | | NCL document is currently being |
| | | presented, it must be stopped first (all |
| | | events on occurring state must be |
| | | stopped). |
| | | To make an application persistent, it is |
| | | required that all files unsolicitedly |
| | | transmitted (pushed data) are already |
| | | stored in the PBDS. |
| saveDocument | 0x2E | Saves an NCL document from an |
| (baseId, | | openprivate base to a non-volatile |
| documenId, | | storage device (if available). The |
| location) | | location parameter may be used to |
| | | specify a diverse location for saving the |
| | | document. The same rule for |
| | | composing the value of the location |
| | | parameter described for the openBase |
| | | command applies to saveDocument. If |
| | | the NCL document is currently being |
| | | presented, it must be stopped first (all |
| | | events on occurring state must be |
| | | stopped). |

As aforementioned, applications can be made persistent (saved). Applications becomes persistent when signaled by the tuned channel (e.g., through the UNBOUND control code of the AIT or through DSM-CC stream event command) or by editing command events (e.g., Class Edit NCLua) issued by an application. Yet another way to save applications and private base is using AppCatUI.

The Application Catalogue User Interface (AppCatUI)

AppCatUI (Application Catalogue User Interface) is an extension of the Ginga middleware that must be provided by the IBB receiver, intended for listing the available applications in the PBDS that can be launched by the end user, adding, moving and removing applications.

The list should identify if the application is persistent or non-persistent. It should also identify the applications for which the minimum resources required for them are already pre-loaded.

The list order displayed by AppCatUI should change dynamically, according to the following priority rules:
First, the service associated applications signaled within the DTV service selected at current time must be shown, differentiated and highlighted, so the end user can clearly identify that such applications are part of the DTV service content. Additionally, the user interface design should grant quicker access to these applications.
Second, the ordering within service associated IBB applications is defined by the order in which applications are declared in the DTV service (e.g., AIT).
Installed and resident applications should be listed in second priority order. Installed applications should be listed first.

Applications and private bases may become persistent (saved) also by means of AppCatUI. In this case, applications must carry the permission for such a procedure when received. The AppCatUI must also allow for listing applications stored in external memory devices. It should also be possible to move or copy to such devices applications in the PBDS that provide permission for this operation. An application stored in an external device can also be copied to the PBDS, more precisely, to the private base defined for installed applications. The AppCatUI should also allow an application to move from the private base associated with a TV channel to the private base defined for installed applications, if the application provides permission for this operation.

The inverse process, that is, the move of an application from the private base defined for installed applications to the private base associated with a TV channel, is possible only if the application is signaled by the channel.

The AppCatUI should allow users to remove applications from the PBDS without restrictions, except for resident applications. Resident applications cannot be added, removed or moved through the AppCatUI.

Applications made persistent by a user command can only be deleted by another user command. However, an application can “invite” the end user to free space by deleting other applications, but the decision is up to the end user (or to a receiver configuration setup by him or her).

The AppCatUI must also include the following functionalities:
Retrieving remote application catalogues from an application repository.
Allow the end user to launch any listed application.
Allow the end user to bring to focus any listed application already in execution.
Allow the end user to terminate any listed application already in execution.
Provide access to the available user-oriented application metadata (such as application name, provider, version, etc.).

The AppCatUI should allow the end user to arrange the installed applications in a customizable hierarchical directory structure in the private base defined for installed applications.

Ginga does not specify how the AppCatUI must be implemented, but only the functionalities that AppCatUI must support. The AppCatUI implementation is a receiver manufacturer decision.

In this invention, the AppCatUI issues control commands onto the Private Base Manager to manipulate the private base being affected by the user activity.

Support for delivering IBB applications using a combination of delivery mechanisms

Since its first standardized version in 2007, Ginga provides support to converged services by making use of broadcast and broadband distribution paths.

NCL applications have a stricter separation between its content and its structure. NCL does not define itself any media content. Instead, it defines the glue that holds media objects together in multimedia presentations. An NCL document (NCL application code) only defines how media objects are structured and related, in time and space. As a glue language, NCL does not restrict or prescribe the content types of its media objects. Which media objects are supported depend on the media players that are coupled in the NCL Presentation Environment. One of these players is the main video and main audio decoder/player, usually implemented using hardware resources in a DTV receiver. Therefore, the main video and the main audio of a service are treated like all other media objects that may be related using NCL.

Another media object that is required in a Ginga-NCL implementation is the HTML-based media object. Which HTML-based language will have support in an NCL player is an implementation choice, and, therefore, it will depend on which HTML browser will act as a media player integrated to the NCL presentation engine.

Still another media object that is required in a Ginga-NCL implementation is the declarative NCL media object, that is, a media object containing an NCL application. Therefore, NCL applications can be embedded in NCL parent applications, likewise HTML-based applications can be.

To extend the NCL declarative language basic model adding decision-making features that deserves the imperative paradigm, NCLua objects are part of the Ginga-NCL specification. Lua is the scripting language of NCL. NCLua media objects carries Lua code based on the standard NCLua API [2] [3]).

Each media object of NCL specifies in its src attribute the URI Scheme used to retrieve its content. Depending on the specified scheme, Ginga knows if it has to get the content from the broadcast signal or from the IP network. For example, if the URI is http://server_identifier/file_path/#fragment_identifier, the content must be retrieved from the IP network, if it is ts://program_number.component_tag, it must be retrieved from the tuned channel signal.

In an implementation in conformance with Ginga specification, the URIs (uniform resource identifiers) defined in Table 3 are defined.

TABLE 3
Allowed URIs

| Scheme | Scheme-specific-part | Use | Agreement |
|---|---|---|---|
| file: | ///file_path/#fragment_identifier | Local files | Required |
| http: | //server_identifier/file_path/#fragment_identifier | Remote files | Required |
| | | downloaded using the | |
| | | HTTP protocol. | |
| | | It can also refer to | |
| | | streams using HTTP-based | |
| | | streaming protocols like | |
| | | MPEG DASH. | |
| https: | //server_identifier/file_path/#fragment_identifier | Remote files downloaded | Required |
| | | using the HTTPS protocol | |
| rtsp: | //server_identifier/file_path/#fragment_identifier | Streams using the RTSP | Optional |
| | | protocol | |
| rtp: | //server_identifier/file_path/#fragment_identifier | Streams using the RTP | Optional |
| | | protocol | |
| ncl- | //media_element_identifier | Content flow identical to | Required |
| mirror: | | the one in presentation by | |
| | | another media element | |
| ts: | //sender_identifier/ | Elementary streams | Required |
| | program_number.component_tag | contained in a transport | |
| | | stream | |
| dsm-cc: | //sender_identifier | Non-real-time | Optional |
| | /program_number.component_tag/ | broadcasting | |
| | carouselId/moduleId/ObjectKey/ | of audio, video, and data | |
| | file_path/#fragment_identifier | files (filecasting) that are | |
| | | to be stored at the receiver | |
| | | for playback at a later | |
| | | time. Transmission uses | |
| | | the DSM-CC protocol. | |
| flute: | //sender_identifier/channel_identifier/ | Non-real-time | Optional |
| | file_path/#fragment_identifier | broadcasting | |
| | | of audio, video, and data | |
| | | files (filecasting) that are | |
| | | to be stored at the receiver | |
| | | for playback at a later | |
| | | time. Transmission uses | |
| | | the FLUTE protocol. | |

The “ts” scheme identifies the elementary stream by its program_number (identification of the service) and component-tag (identification of an elementary stream of the identified service). It should be emphasized that references to streaming video or audio resources shall not cause tuning of the associated DTV service. References that imply tuning to access a resource behaves as if the resource were unavailable. Relative URI is also allowed in using “ts” scheme. In this case, sender_identifier can be omitted, and the source of the tuned “ts” shall be assumed.

The “dsm-cc” scheme identifies the sender, the specific elementary stream (like in “ts” scheme), the carousel in which the content is encoded, a module in this carousel and the object whose URI is the base for the relative URI specified in the scheme. Relative URI is also allowed in using “dsm-cc” scheme. In this case, sender_identifier can be omitted, and the source of the tuned “ts” shall be assumed. The program_number.component_tag/carouseIId/moduleId/ObjectKey can also be omitted if: (i) it refers to the NCL document pushed in the same carousel, and if this part of the URI can be inferred, for example, from NCL Editing commands; (ii) if it refers to the object (file_path does not exist), and if this part of the URI can be inferred, for example, from NCL Editing commands.

The “flute” scheme identifies the sender and the channel (service) to which a session is established. Relative URI is also allowed in using “flute” scheme. In this case, channel_identifier can be omitted if there is just one channel. The file_path can also be omitted if it is the same of the NCL document pushed in the same channel, and if this part of the URI can be inferred, for example, from NCL Editing commands.

Note:
a) In ISDB-T [3], the ts scheme is substituted by sbtvd-ts, and the sender_identifier must be omitted and the source of the tuned “ts” shall be assumed.
b) The URI file:///networkld/url_path/#fragment_identifier or file:///networkld/networkld.program_number/url_path/#fragment_identifier addresses data files in the private base data structure (PBDS) of Ginga
c) The URI file:///extStorage/url_path/#fragment_identifier addresses data files in the external persistent memory of a receiver that supports Ginga.
Note that an application addresses only one external storage device mapped by the Ginga implementation.

The main NCL document (application code that starts the presentation) can be received from different means.
1. Service associated NCL applications can come from the tuned broadcast channel using DSMCC-OC, or from tuned broadband channel (e.g. an IPTV service) using DSMCC-OC, FLUTE or HTTP (HTTPS) protocol. When using http protocol, code can be delivered in zip packages.
2. Service associated NCL applications can also come from a Web application repository (using http protocol, code can be delivered in packages such as zip packages) or from an external storage system. In this case, the command to load the application must come from a tuned broadcast or broadband channel, or the application must be signed.
3. Stand-alone applications (both installed applications and resident applications) can come from a broadcast channel, a broadband channel, a Web application repository, an external storage system and home area network (HAN).

Application metadata can come embedded in an NCL document; using mechanism such as AIT table, DSMCC stream events, DSMCC Object Carousel, or FLUTE via a tuned broadcast or broadband channel; or using http protocol to access a repository.

When using an application installation package, code, resources, and meta-data would usually be bundled together in the same package.

Service associated applications must be placed in the PBDS into the private base associated with the tuned channel or into a private base nested in the private base of the tuned channel.

Resident applications are placed into the specific private base for resident applications. Installed applications are placed into the specific private base for installed applications.

Application life cycle model

The application life cycle model is equivalent to the one defined by [2] and [3]. Applications can be signaled as being bounded to the service or not. Defined rules are:
Execution of service-exclusive (service bounded) applications must be terminated when the service exhibition is stopped.
In the case of service-shared (service unbounded) applications, execution should continue in the case of the same application being also signaled in the service that is selected next.
   Both service exclusive and service shared applications are to be considered service associated applications and must be terminated in the case of no longer being signaled within the currently selected DTV service.

Ginga allows several applications to run simultaneously. Application life cycle manager is a function of Ginga intended to manage the task/execution of currently running applications consistent with service integrity. The AppCatUI must allow the end user to manage the application lifecycle. The following functionalities should be provided in the user interface for the application lifecycle manager:
Allowing the end user to bring to focus any listed application already in execution.
Allowing the end user to terminate any listed application already in execution.
Show only the currently running DTV service applications that can be terminated by the user. In the case of service associated DTV applications, only those that are allowed by the DTV service provider to be terminated by the user should be displayed.
Optionally providing access to the available user-oriented application meta-data (such as application name, provider, version, etc.).

IBB Application Control

Ginga allows the DTV service provider to control the execution, availability and visibility of their service associated applications. The DTV service providers cannot control applications which are not signaled in their DTV service and manually started by the user.

DTV service providers can control the execution, availability and visibility of the applications, using mechanisms available through the AIT and through stream events, e.g., NCL Editing Commands.

Ginga allow for applications being launched in the following ways:
a) signaled to be auto-started in the current selected DTV Service, through using mechanisms available in the AIT and stream events (e.g., NCL Editing Commands);
b) started by an already existing application by using NCL Editing Commands;
c) started by an (parent) NCL application that embeds the application;
d) started by the instruction from the AppCatUI.

Application termination should occur if:
a) signaled to be KILLed or DESTROYed in the current selected DTV service;
b) signaled to be stopped by a stream event (e.g., an NCL Editing Command) in the current selected DTV service;
c) it was started as a service associated application and it has been removed from the DTV service's private base;
d) other service associated application (with proper permissions) stops the application by using NCL Editing Commands;
e) it was started by a parent application that has been terminated;
f) an end user stops the application by using an instruction from the AppCatUI;
g) the application terminates itself;
h) an exception is raised and it is not handled by the application; or
i) a DTV receiver runs out of enough resources to execute the application.

A Ginga implementation must grant the isolation between the running applications within its scope, but the DTV receiver must provide isolation from other platform applications. This is important for stand-alone applications that may not be aware of other native applications executed in the system.

Home Area Network Integration

Since its first standardized version of 2007, NCL and Ginga provide declarative support for presenting DTV applications distributed on multiple devices, namely multiple companion devices and multi-user control [2] [3].

Presentation of media objects of NCL applications can be associated to devices using the abstraction called device classes. Secondary devices (child devices) are registered to classes controlled by a parent device.

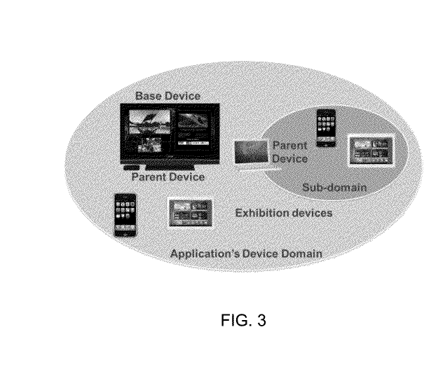

The parent device can be the base device or any descendent secondary device. The parent device can delegate control to child devices registered in its active classes. From these secondary devices, it is possible to create new sub-domains (new classes under control of the new parent device), forming a hierarchical application domain, as shown in FIG. 3.

In defining a class, it is possible to define the maximum and minimum number of devices it has. This mechanism comes together with a method to identify each device in a class. For each media object, NCL allows for defining in which class of devices must be exhibited and in which region on the screens of all devices registered in the class.

NCL 3.0 [3] has originally defined two types of device classes: the passive one, in which the same content is shown on all paired devices under the rendering of their parent device; and the active one, in which the content exhibition is rendered by each individual child device, thus allowing independent navigation and interaction.

In NCL 3.0 dynamic class specifications are not supported. In addition, which protocols underlie the communication between the cooperating devices is left to Ginga proprietary implementations, although they shall follow the standardized multiple device API. NCL version 3.1 [2] removes these limitations.

In addition to NCL 3.0 default feature to define passive and active classes, mechanisms were introduced in NCL 3.1 for describing specific capabilities a device aiming at registering to a class must have. It is also possible to dynamically associate states and arbitrary parameters to already defined device classes. Secondary device registrations and deregistration on these classes are conditioned to this dynamic parameters and states. The media capture class was also introduced. Devices registered in this class can capture media content to be presented on its parent device. The on-demand media class was also introduced. Devices registered in this class are able to browse a list of media content and request media on demand. The shared list is managed by the parent device. Finally, the protocols and APIs for device communication were standardized.

Effects and Advantages

Ginga IBB has the following advantages over other IBB solutions:
Ginga IBB defines a formal structure called PBDS, which applications can traverse and reflectively get information about themselves and about other available applications.
Broadcasters, IBB applications and Ginga Extensions can manipulate the PBDS to manage applications' lifecycle, change their behavior on-the-fly as well as setup their persistency needs.
A well-defined control API is used to pass commands to the Private Base Manager, from the broadcaster via AIT signaling and DSM-CC stream events and from IBB applications, via the Live Editing API.
Its support for multiple companion devices, which are organized hierarchically and easily identified by device classes instead of network addresses, takes advantage of the inherent spatiotemporal synchronization of the NCL language to allow developers to create rich, multi-screen, distributed IBB applications. No other programming language available in IBB systems supports the level of synchronization defined in NCL's model.
Existent NCL applications developed for DTV services work seamlessly in Ginga IBB, since it adopts the same NCL language and basic control commands standardized for DTV and IPTV services. Therefore, different from other IBB systems, Ginga IBB is backward compatible with legacy DTV services based on NCL.
In summary, the new features and approaches described in this innovation are: the PBDS; a new architecture where the Private Base Manager becomes a 1^{st} class module and can receive commands from broadcasters (AIT, stream events), from NCL applications (Live Editing API) and from the user (AppCatUI); new control commands and signaling options for better IBB support, regarding persistence management and support for external memories; the AppCatUI; the possibility for Broadcasters (via AIT) and developers (via Live Editing API) to change the behavior of NCL applications on-the-fly; and NCL's intrinsic capability to synchronize multiple devices in an IBB environment.

### REFERENCES

[1] Recommendation ITU-T J.205 (2014), Requirements for an application control framework using integrated broadcast and broadband digital television
[2] Recommendation ITU-T H.761 (2014), Nested Context Language (NCL) and Ginga-NCL
[3] Standard ABNT NBR 15606-2 (2015),
[4] ETSI TS 102 796 V1.2.1 (2012-11), Hybrid Broadcast Broadband TV.
[5] ARIB STD-B62 (2014), Multimedia Coding Specification for Digital Broadcasting (Second Generation)

What is claimed is:

1. A system comprising creation of an architecture for and implementation of Middleware (Ginga IBB) for integrated broadcast and broadband digital television, and multimedia services.

2. The system according to claim 1, wherein to be Ginga IBB compliant the system must have the Ginga Common-Core (Ginga-CC)(1), Ginga-NCL (2), the Private Base Manager (3) and AppCatUI (4) subsystems.

3. The system according to claim 2, wherein the Private Base Manager (3) is considered a first-class entity of the Ginga IBB architecture, being positioned directly coupled to the Ginga Common-Core (1) and used by Ginga-NCL (2), AppCatUI (4) and Ginga extensions.

4. The system according to claim 2, wherein the Private Base Manager (3) centralizes all controlling commands over IBB applications' lifecycle, persistence and behavior changing.

5. The system according to claim 2, wherein the Private Base Manager (3) component is also tasked with receiving NCL editing commands and control commands delivered using AIT table control_code field, and maintaining the lifecycle of NCL applications being presented.

6. The system according to claim 2, wherein the Ginga Common Core (Ginga-CC) (1) is composed of media players (5), procedures to obtain contents that can be transported in diverse networks accessed by a receiver (6), and the conceptual display graphical model defined by the receiver platform (7).

7. The system according to claim 2, wherein the Ginga Common Core (Ginga-CC) (1) is also tasked with gathering metadata information (6) and providing this information to NCL applications; for providing an API to communicate with DRM system (8); for managing context information (9); and for supporting software version management of Ginga's components (10).

8. The system according to claim 2, wherein the core of Ginga-NCL (2) subsystem is the NCL Player (12).

9. The system according to claim 2, wherein the Ginga-NCL Presentation Engine (2) supports multiple presentation devices or companion devices through its Layout Manager module and is responsible for mapping al presentation regions defined in an NCL application to canvas on receiver's displays.

10. The system according to claim 2, wherein the AppCatUI (4) is an extension of the Ginga middleware that must be provided by the IBB receiver, intended for listing the available applications in the Private Base Data Structure that can be launched by the end user, adding, moving and removing applications.

11. The system according to claim 2, wherein the list order displayed by AppCatUI (4) changes dynamically, according to the following priority rules:
(a) first, the service associated applications signaled within the DTV service selected at current time must be shown, differentiated and highlighted, so the end user can clearly identify that such applications are part of the DTV service content and additionally, the user interface design grants quicker access to these applications;
(b) second, the ordering within service associated IBB applications is defined by the order in which applications are declared in the DTV service (e.g., AIT); and
(c) installed and resident applications are listed in second priority order, with installed applications listed first.

12. The system according to claim 2, wherein the AppCatUI (4) must also include the following functionalities:
(a) retrieving remote application catalogues from an application repository;
(b) allow the end user to launch any listed application;
(c) allow the end user to bring to focus any listed application already in execution;
(d) allow the end user to terminate any listed application already in execution; and
(e) provide access to the available user-oriented application metadata.

13. The system according to claim 2, wherein the AppCatUI (4) issues control commands onto the Private Base Manager to manipulate the private base being affected by the user activity.

14. The system according to claim 2, wherein the NCLua objects are part of the Ginga-NCL (2) specification for adding decision-making features that deserves the imperative paradigm.

15. The system according to claim 14, wherein the NCLua media objects carries Lua code based on the standard NCLua API.

16. The system according to claim 2, wherein it is applied for life cycle model with the following functionalities:
(a) allowing the end user to bring to focus any listed application already in execution;
(b) allowing the end user to terminate any listed application already in execution;
(c) show only the currently running DTV service applications that can be terminated by the user and in the case of service associated DTV applications, only those that are allowed by the DTV service provider to be terminated by the user should be displayed; and
(d) optionally providing access to the available user-oriented application meta-data.

17. The system according to claim 2, wherein it is applied for IBB application control, where Ginga allows applications to be launched in the following ways:
(a) signaled to be auto-started in the current selected DTV Service, through using mechanisms available in the AIT] and stream events (e.g., NCL Editing Commands);
(b) started by an already existing application by using NCL Editing Commands;
(c) started by an (parent) NCL application that embeds the application; and
(d) started by the instruction from the AppCatUI,
wherein application termination should occur if:
(a) signaled to be KILLed or DESTROYed in the current selected DTV service;
(b) signaled to be stopped by a stream event (e.g., an NCL Editing Command) in the current selected DTV service;
(c) it was started as a service associated application and it has been removed from the DTV service's private base;
(d) other service associated application (with proper permissions) stops the application by using NCL Editing Commands;
(e) it was started by a parent application that has been terminated;
(f) an end user stops the application by using an instruction from the AppCatUI;
(g) the application terminates itself;
(h) an exception is raised and it is not handled by the application; or
(i) a DTV receiver runs out of enough resources to execute the application.

18. The system according to claim 2, wherein it is applied for Home area network integration, by supporting multiple companion devices to be included in rich distributed multimedia presentations.

19. The system according to claim 2, wherein presentation of media objects of applications is associated to companion devices using an abstraction called device classes, to which the companion devices in a home area network are registered.

20. The system according to claim 2, wherein companion devices form a hierarchical application domain, wherein the parent device is the IBB receiver or any descendent companion device, and the parent device delegates control to registered child devices, from where new sub-domains in the form of new classes under control of the new parent device are created.
